(19) United States
(12) Patent Application Publication
(10) Pub. No.: US 2024/0126903 A1
(43) Pub. Date: Apr. 18, 2024

(54) SIMULATION OF EDGE COMPUTING NODES FOR HCI PERFORMANCE TESTING

(71) Applicant: Dell Products L.P., Round Rock, TX (US)

(72) Inventors: Hongwei YUE, Shanghai (CN); Kai CHEN, Shanghai (CN); Shunhua XIE, Shanghai (CN)

(73) Assignee: Dell Products L.P., Round Rock, TX (US)

(21) Appl. No.: 17/977,801

(22) Filed: Oct. 31, 2022

(30) Foreign Application Priority Data
Oct. 13, 2022 (CN) 202211257833.7

(51) Int. Cl. G06F 21/62

(52) U.S. Cl. CPC G06F 21/6218

(57) ABSTRACT

An information handling system may include at least one processor and a memory. The information handling system may be configured to: receive a request to create a plurality of virtual computing nodes; build at least one parent virtual computing node based on an operating system image; create a plurality of clone virtual computing nodes by copying the at least one parent virtual computing node; for each of the plurality of clone virtual computing nodes, reconfigure at least one setting of the clone virtual computing node, such that none of the reconfigured clone virtual computing nodes are identical to one another; and run the plurality of reconfigured clone virtual computing nodes.

### TECHNICAL FIELD

The present disclosure relates in general to information handling systems, and more particularly to techniques for simulations of edge computing nodes for performance testing.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCl) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCl solution is the Dell EMC VxRail™ system. Some examples of HCl systems may operate in various environments (e.g., an HCl management system such as the VMware® vSphere® ESXi™ environment, or any other HCl management system). Some examples of HCl systems may operate as software-defined storage (SDS) cluster systems (e.g., an SDS cluster system such as the VMware® vSAN™ system, or any other SDS cluster system).

In the HCl context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCl systems are used to support edge computing scenarios that include huge numbers of edge nodes, which may be mapped to satellite nodes in the HCl system. Accordingly, it is valuable to be able to simulate a huge number of satellite nodes in an HCl performance-testing system. Existing techniques for simulating large numbers of satellite nodes are costly in terms of both time and hardware resources. Embodiments of this disclosure thus provide improved techniques for performing such simulations.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with performance testing in information handling systems may be reduced or eliminated.

In accordance with embodiments of the present disclosure, an information handling system may include at least one processor and a memory. The information handling system may be configured to: receive a request to create a plurality of virtual computing nodes; build at least one parent virtual computing node based on an operating system image; create a plurality of clone virtual computing nodes by copying the at least one parent virtual computing node; for each of the plurality of clone virtual computing nodes, reconfigure at least one setting of the clone virtual computing node, such that none of the reconfigured clone virtual computing nodes are identical to one another; and run the plurality of reconfigured clone virtual computing nodes.

In accordance with these and other embodiments of the present disclosure, a method may include an information handling system receiving a request to create a plurality of virtual computing nodes; the information handling system building at least one parent virtual computing node based on an operating system image; the information handling system creating a plurality of clone virtual computing nodes by copying the at least one parent virtual computing node; for each of the plurality of clone virtual computing nodes, the information handling system reconfiguring at least one setting of the clone virtual computing node, such that none of the reconfigured clone virtual computing nodes are identical to one another; and the information handling system running the plurality of reconfigured clone virtual computing nodes.

In accordance with these and other embodiments of the present disclosure, an article of manufacture may include a non-transitory, computer-readable medium having computer-executable instructions thereon that are executable by a processor of an information handling system for: receiving a request to create a plurality of virtual computing nodes; building at least one parent virtual computing node based on an operating system image; creating a plurality of clone virtual computing nodes by copying the at least one parent virtual computing node; for each of the plurality of clone virtual computing nodes, reconfiguring at least one setting of the clone virtual computing node, such that none of the reconfigured clone virtual computing nodes are identical to one another; and running the plurality of reconfigured clone virtual computing nodes.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of an example architecture, in accordance with embodiments of the present disclosure.

### DETAILED DESCRIPTION

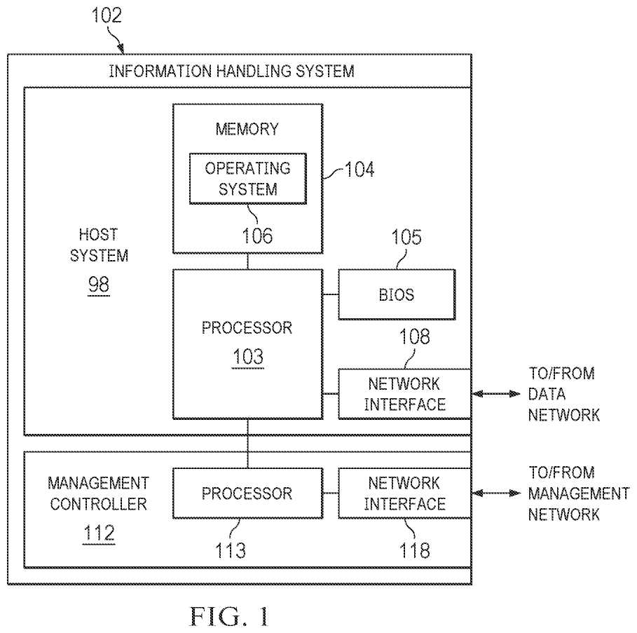

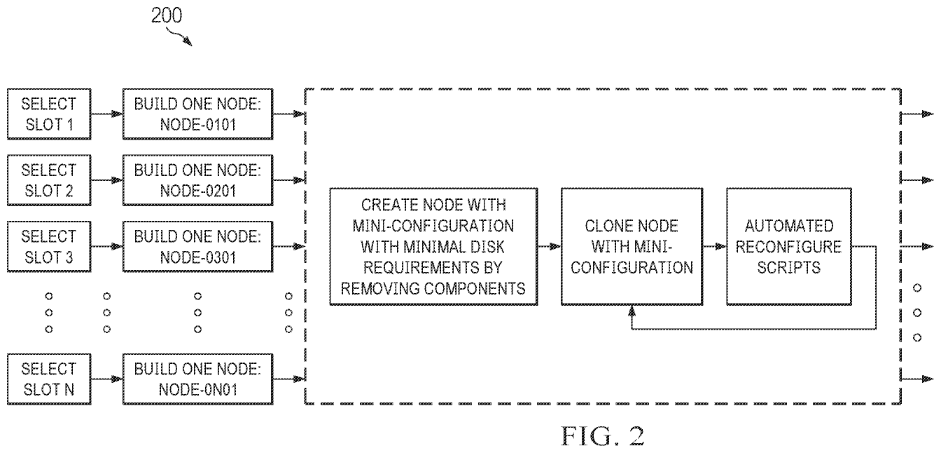

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the field of simulating a large number of satellite nodes in an HCl system. Existing techniques for performing such simulations are essentially manual, and they tend to be costly in terms of both time and hardware resources.

Embodiments of this disclosure improve on existing techniques by leveraging a virtual HCl platform to build satellite nodes, configure the nodes, and perform simulations of networking and customer workload scenarios on the satellite nodes.

Turning now to FIG. 2, an example architecture 200 is shown for performing a simulation of a large number of HCl edge nodes. In some embodiments, architecture 200 may run on the edge computing HCl system in question (e.g., implemented as one or more microservices). In other embodiments, architecture 200 may run on another information handling system.

As shown, architecture 200 may select N HCl information handling systems in N physical slots for performing the simulation. In parallel, for each of the N slots, a single “parent” node is first created using whatever operating system image is desired. These parent nodes may be created as minimal nodes with any unnecessary components omitted, and with relatively low hardware resource configurations (e.g., vCpu=2, vMemory=2G, disk=200G, etc.) in order to reduce the hardware costs and the time needed to create the nodes. For example, various management components, troubleshooting components, etc. that will not be used in this scenario may be removed from the operating system image when creating the parent nodes.

These parent nodes may then be cloned any desired number of times. For example, a user might decide to instantiate 100 of such minimal nodes on each hardware slot, and so each parent node might be cloned 99 times.

After the cloning is finished, one or more automated reconfiguration scripts may modify the system settings and HCl configurations of each node (e.g., the parent node and all its clones) to match the real physical parameters of the desired edge nodes and to make the clones distinguishable from one another. For example, the reconfiguration scripts may modify the node model type, the product serial number tag, the MAC address of the network adapter, the system UUID, and any other suitable settings for each node. The scripts may also rebuild local data storage, configure a management IP address and network routing rules, and generate network simulation settings appropriate for the edge nodes.

Once the virtual HCl nodes have finished being reconfigured, each node's configuration metadata (e.g., its management IP address, slot number, cluster number, etc.) may be saved into a central management database. This metadata may also be used to help simulate different scenarios, such as determining the maximum number of concurrent edge nodes that can be supported under different edge network configurations.

In some embodiments, architecture 200 may be implemented as a parallel model. For example, each thread might support cloning and preparing 99 nodes, and so to prepare 500 or more satellite nodes, 5 or more threads could be run concurrently. Accordingly, any desired large number of satellite nodes and configurations may be created and be ready in a very short time and with low processing costs.

As one example, consider a scenario of setting up 1,000 HCl nodes for simulating a large-scale satellite node cluster. Ten hardware slots may be selected from one or more HCl clusters (e.g., slot 1 cluster 1, slot 2 cluster 2, etc.), with each slot supporting 100 satellite nodes. A selected number (e.g., ten) minimal virtual HCl nodes may then be launched on the hardware slots concurrently. The cloning and reconfiguration of the first ten minimal virtual HCl nodes may then also be carried out in parallel, resulting in a system of 1,000 satellite nodes in a relatively short amount of time.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive a request to create a plurality of virtual computing nodes;
build at least one parent virtual computing node based on an operating system image;
create a plurality of clone virtual computing nodes by copying the at least one parent virtual computing node;
for each of the plurality of clone virtual computing nodes, reconfigure at least one setting of the clone virtual computing node, such that none of the reconfigured clone virtual computing nodes are identical to one another; and
run the plurality of reconfigured clone virtual computing nodes.

2. The information handling system of claim 1, wherein building the at least one parent virtual computing node comprises removing at least one component from the operating system image prior to building the at least one parent virtual computing node.

3. The information handling system of claim 1, further configured to reconfigure the at least one parent virtual computing node and run the reconfigured at least one parent virtual computing node.

4. The information handling system of claim 1, wherein the at least one parent virtual computing node comprises a plurality of parent virtual computing nodes, and wherein the plurality of parent virtual computing nodes are each configured to run on a separate physical information handling system slot.

5. The information handling system of claim 1, wherein the information handling system is a hyper-converged infrastructure (HCl) system.

6. The information handling system of claim 5, wherein the plurality of reconfigured clone virtual computing nodes are edge computing nodes of the HCl system.

7. A method comprising:
an information handling system receiving a request to create a plurality of virtual computing nodes;
the information handling system building at least one parent virtual computing node based on an operating system image;
the information handling system creating a plurality of clone virtual computing nodes by copying the at least one parent virtual computing node;
for each of the plurality of clone virtual computing nodes, the information handling system reconfiguring at least one setting of the clone virtual computing node, such that none of the reconfigured clone virtual computing nodes are identical to one another; and
the information handling system running the plurality of reconfigured clone virtual computing nodes.

8. The method of claim 7, wherein building the at least one parent virtual computing node comprises removing at least one component from the operating system image prior to building the at least one parent virtual computing node.

9. The method of claim 7, further comprising reconfiguring the at least one parent virtual computing node and running the reconfigured at least one parent virtual computing node.

10. The method of claim 7, wherein the at least one parent virtual computing node comprises a plurality of parent virtual computing nodes, and wherein the plurality of parent virtual computing nodes are each configured to run on a separate physical information handling system slot.

11. The method of claim 7, wherein the information handling system is a hyper-converged infrastructure (HCl) system.

12. The method of claim 11, wherein the plurality of reconfigured clone virtual computing nodes are edge computing nodes of the HCl system.

13. An article of manufacture comprising a non-transitory, computer-readable medium having computer-executable instructions thereon that are executable by a processor of an information handling system for:
receiving a request to create a plurality of virtual computing nodes;
building at least one parent virtual computing node based on an operating system image;
creating a plurality of clone virtual computing nodes by copying the at least one parent virtual computing node;
for each of the plurality of clone virtual computing nodes, reconfiguring at least one setting of the clone virtual computing node, such that none of the reconfigured clone virtual computing nodes are identical to one another; and
running the plurality of reconfigured clone virtual computing nodes.

14. The article of claim 13, wherein building the at least one parent virtual computing node comprises removing at least one component from the operating system image prior to building the at least one parent virtual computing node.

15. The article of claim 13, wherein the instructions are further executable for reconfiguring the at least one parent virtual computing node and running the reconfigured at least one parent virtual computing node.

16. The article of claim 13, wherein the at least one parent virtual computing node comprises a plurality of parent virtual computing nodes, and wherein the plurality of parent virtual computing nodes are each configured to run on a separate physical information handling system slot.

17. The article of claim 13, wherein the information handling system is a hyper-converged infrastructure (HCl) system.

18. The article of claim 17, wherein the plurality of reconfigured clone virtual computing nodes are edge computing nodes of the HCl system.
